(19) United States
(12) Patent Application Publication
(10) Pub. No.: US 2007/0086117 A1
(43) Pub. Date: Apr. 19, 2007

(54) Actuator with improved voice coil motor and hard disk drive having the same

(75) Inventor: Chul-Woo Lee, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/493,653

(22) Filed: Jul. 27, 2006

(30) Foreign Application Priority Data
Oct. 18, 2005 (KR) 2005-98072

(51) Int. Cl. G11B 5/55

(52) U.S. Cl. 360/264.7

(57) ABSTRACT

An actuator with an improved VCM and a hard disk drive having the actuator. The actuator can include an actuator pivot, a swing arm rotatably coupled to the actuator pivot, a coil support provided on a rear end of the swing arm; and a VCM providing a driving force for rotation of the actuator. The VCM can include a VCM coil coupled to the coil support and a magnet disposed at at least one side of a top side and a bottom side of the VCM coil. The VCM coil includes a first portion and a second portion that are spaced apart from each other and arranged in a direction substantially perpendicular to a rotating direction of the actuator, and a third portion and a fourth portion that connect both ends of the first portion to corresponding ends of the second portion and respectively arranged in the rotating direction of the actuator. The third portion is disposed close to the actuator pivot, and the fourth portion is disposed away from the actuator pivot. The magnet faces the first portion, the second portion, and the third portion of the VCM coil. Therefore, the power efficiency of the VCM can be improved and the driving force of the VCM can be increased.

### CROSS-REFERENCE TO RELATED APPLICATIONS

This application claims the benefit of Korean Patent Application No. 10-2005-0098072, filed on Oct. 18, 2005, in the Korean Intellectual Property Office, the disclosure of which is incorporated herein in its entirety by reference.

### BACKGROUND OF THE INVENTION

1. Field of the Invention

The present general inventive concept relates to a hard disk drive, and more particularly, to an actuator with a voice coil motor having improved power efficiency.

2. Description of the Related Art

A hard disk drive (HDD), being one type of data storage of a computer, reproduces data from a disk and/or records data on the disk using a read/write head. In such an HDD, the read/write head moves to a desired position while moving above a recording surface of a rotating disk by means of an actuator and executes reproducing/recording functions.

FIG. 1 is a schematic perspective view illustrating a structure of a conventional HDD, FIG. 2 is a plan view of the conventional actuator depicted in FIG. 1, and FIG. 3 is a cross-sectional view taken along line A-A′ of FIG. 2 to illustrate a conventional voice coil motor.

Referring to FIGS. 1 through 3, the HDD includes a data storage disk 10, a spindle motor 20 spinning the disk 10, and an actuator 30 moving a read/write head to a desired position on the disk 10 for recording and reproducing data. The actuator 30 includes a swing arm 32 rotatably installed on a pivot 31, a suspension 33 installed on a leading end of the swing arm 32 for supporting and elastically biasing a slider 34 with the read/write head toward a surface of the disk 10, and a voice coil motor (VCM) 36 providing a driving force for rotating the swing arm 32. The VCM 36 includes a VCM coil 37 coupled to a coil support 35 provided on a rear end of the swing arm 32, and magnets 38 facing the VCM coil 37 from above and below the VCM coil 37.

The VCM 36 with the above-described structure rotates the swing arm 32 in a direction according to Fleming's left-hand rule by the interaction between a current applied to the VCM coil 37 and a magnetic field formed by the magnets 38. That is, when the HDD is powered and the disk 10 starts rotating, the VCM 36 rotates the swing arm 32 in a predetermined direction (e.g., counterclockwise) to move the slider 34 with the read/write head above a recording surface of the disk 10. The slider 34 is lifted up to a predetermined height from the surface of the disk 10 by a lift force generated by the rotation of the disk 10. In this state, the read/write head mounted on the slider 34 records data on the recording surface of the disk 10 or reproduces data from the recording surface of the disk 10. Meanwhile, when the HDD is turned off and the disk 10 stops rotating, the VCM 36 rotates the swing arm 32 in an opposite direction (e.g., clockwise) to move the slider 34 away from the recording surface of the disk 10.

The conventional VCM 36 will now be more fully described.

The VCM 37 coil has an approximately rectangular shape. The VCM coil 37 includes two portions arranged in a rotating direction of the actuator 30 and two portions arranged in a perpendicular direction to the rotating direction of the actuator 30. Each of the magnets 38, as illustrated in FIG. 3, has two poles, N and S poles. Such magnets 38 are usually attached to yokes 39. The magnets 38 face the two portions of the four portions of the VCM coil 37 that are arranged in the perpendicular direction to the rotating direction of the actuator 30.

Referring again to FIG. 2, when a current is applied to the VCM coil 37 in a predetermined direction, a force F acts on the VCM coil 37 in a direction according to Fleming's left-hand rule by the interaction between the current and a magnetic field formed by the magnets 38. The force F acts in a perpendicular direction to the two portions of the VCM coil 37 facing the magnets 38. That is, the force F acts in the rotating direction of the actuator 30. Accordingly, the actuator 30 swings on the pivot 31.

As described above, in the conventional VCM 36, to generate the force F in the same direction as the rotating direction of the actuator 30, the magnets 38 face only the two portions of the four portions of the VCM coil 37 that are arranged in a perpendicular direction to the rotating direction of the actuator 30.

Therefore, in the conventional actuator 30, the remaining two portions of the VCM coil 37, that is, the two portions arranged in the rotating direction of the actuator 30, do not contribute to the generation of the rotating force, but do cause a power loss due to their electrical resistance, thereby lowering power efficiency of the HDD.

### SUMMARY OF THE INVENTION

The present general inventive concept provides an actuator with an improved voice coil motor to increase power efficiency and a hard disk drive having the actuator.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an actuator to move a read/write head to a predetermined position on a disk to record data on the disk and to reproduce data from the disk, the actuator including: an actuator pivot; a swing arm rotatably coupled to the actuator pivot, the swing arm having a leading end on which a suspension is mounted for supporting the read/write head; a coil support provided on a rear end of the swing arm; and a VCM (voice coil motor) including a VCM coil coupled to the coil support to provide a driving force for rotation of the actuator, and a magnet disposed at at least one side of a top side and a bottom side of the VCM coil, wherein the VCM coil includes a first portion and a second portion that are spaced apart from each other and arranged in a direction substantially perpendicular to a rotating direction of the actuator, and a third portion and a fourth portion that connect both ends of the first portion to corresponding ends of the second portion and respectively arranged in the rotating direction of the actuator, the third portion being disposed close to the actuator pivot, the fourth portion being disposed away from the actuator pivot, and the magnet faces the first portion, the second portion, and the third portion of the VCM coil.

Each of the first portion and the second portion of the VCM coil may receive a force in the same direction as the rotating direction of the actuator, and the third portion of the VCM coil may receive a torque causing the actuator to rotate on the actuator pivot in the same direction as the rotating direction of the actuator.

The VCM coil may have an approximately rectangular shape.

The magnet may be divided into parts with respect to a longitudinal axis of the actuator, the parts being respectively disposed at both sides of the longitudinal axis with opposite poles facing each other.

The magnet may include: an upper magnet disposed above the VCM coil; and a lower magnet disposed under the VCM coil. In this case, each of the upper magnet and the lower magnet may be divided into two parts with respect to a longitudinal axis of the actuator, the two parts being respectively disposed at both sides of the longitudinal axis with opposite poles facing each other, the two parts of the upper magnet facing the two parts of the lower magnet with opposite poles facing each other.

The foregoing and/or other aspects and utilities of the present general inventive concept are also achieved by providing a hard disk drive including: a data storage disk; a spindle motor to spin the disk; and an actuator to move a read/write head to a predetermined position on the disk to record data on the disk and to reproduce data from the disk, the actuator including an actuator pivot, a swing arm rotatably coupled to the actuator pivot and including a leading end on which a suspension is mounted to support the read/write head, a coil support provided on a rear end of the swing arm, and a VCM including a VCM coil coupled to the coil support to provide a driving force for rotation of the actuator and a magnet disposed at at least one of a top side and a bottom side of the VCM coil, wherein the VCM coil includes a first portion and a second portion that are spaced apart from each other and arranged in a direction substantially perpendicular to a rotating direction of the actuator, and a third portion and a fourth portion that connect both ends of the first portion to corresponding ends of the second portion and respectively arranged in the rotating direction of the actuator, the third portion being disposed close to the actuator pivot, the fourth portion being disposed away from the actuator pivot, and the magnet faces the first portion, the second portion, and the third portion of the VCM coil.

The foregoing and/or other aspects and utilities of the present general inventive concept are also achieved by providing an actuator to move a read/write member to a predetermined position along a disk that records data on the disk and reproduces data from the disk, the actuator including: an actuator pivot; a swing arm positioned on the actuator pivot and including the read/write member connected thereto at one end and a coil support extending from the other end thereof; a VCM coil disposed within the coil support and having four approximate sides, a first two of the sides opposing each other and positioned substantially parallel with a rotation direction of the swing arm and a second two of the sides connecting respective ends of the first two of the sides and positioned substantially perpendicular with the first two of the sides and extending along a lengthwise axis of the swing arm, one of the second two sides being positioned close to the actuator pivot; and at least one pair of magnets, each pair of magnets being separated by the lengthwise axis of the swing arm such that one of each pair of the magnets faces one of the first two sides of the VCM coil and the one of the second two sides of the VCM coil being positioned close to the actuator pivot and the other of each pair of the magnets faces the other of the first two sides of the VCM coil and the one of the second two sides of the VCM coil being positioned close to the actuator pivot.

Each pair of magnets being separated by the lengthwise axis of the swing arm can have opposite poles facing each other such that when a current is sent through the VCM coil, a first force is applied to the one of the first two sides of the VCM coil, a second force is applied to the second of the first two sides of the VCM coil, a third force is applied to one side of the one of the second two sides of the VCM coil being positioned close to the actuator pivot and a fourth force is applied to another side of the one of the second two sides of the VCM coil being positioned close to the actuator pivot.

The foregoing and/or other aspects and utilities of the present general inventive concept are also achieved by providing a method of controlling a VCM driven actuator used to read and write from and to a disk of a hard disk drive, the method including applying a force to each of three sides of a four sided VCM coil provided on the actuator to rotate the actuator via a combination of the three forces.

The applying of a force to each of the three forces may include positioning at least one first magnet to face one of the three sides of the VCM coil and a first portion of a second side of the VCM coil; positioning at least one second magnet to face a third one of the three sides of the VCM coil and a second portion of the second side of the VCM coil, the first and third sides of the VCM coil being positioned parallel with the length of the actuator, and the second side of the VCM coil being parallel with a rotation direction of the actuator and substantially perpendicular with the first and third sides of the VCM coil; and providing a current through the VCM coil to interact with the magnets to generate the forces applied to the three sides of the VCM coil.

The positioning of the at least one first magnet and the at least one second magnet may include positioning a first magnet at each side of the VCM coil and positioning a second magnet at each side of the VCM coil such that the magnets have opposite poles facing each other.

The foregoing and/or other aspects and utilities of the present general inventive concept are also achieved by providing a method of controlling a VCM driven actuator used to read and write from and to a disk of a hard disk drive, the method including applying opposing forces to one side of a four sided VCM coil provided on a rear portion of the actuator to create an overall torque to rotate the actuator, the one side of the VCM coil being positioned in parallel with a rotation direction of the actuator.

The applying opposing forces may include positioning a first magnet to face a first portion of the one side of the VCM coil and positioning a second magnet to face a second portion of the one side of the VCM coil, and passing a current through the VCM coil to generate a first force that is applied to the first portion of the one side of the VCM coil and to generate a second force that is applied to the second portion of the one side of the VCM coil such that the first and second forces create the overall torque.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic perspective view illustrating a structure of a conventional hard disk drive (HDD);

FIG. 2 is a plan view of a conventional actuator depicted in FIG. 1;

FIG. 3 is a cross-sectional view taken along line A-A′ of FIG. 2 to illustrate a conventional voice coil motor;

FIG. 4 is a plan view of an HDD provided with an actuator according to an embodiment of the present general inventive concept;

FIG. 5 is a plan view of the actuator depicted in FIG. 4;

FIGS. 6A and 6B are cross-sectional views respectively taken along line B-B′ and line C-C′ of FIG. 5 to illustrate a voice coil motor (VCM) according to an embodiment of the present general inventive concept; and

FIG. 7 is a plan view illustrating an example of an actuator for comparison purposes with the actuator of embodiments of the present general inventive concept.

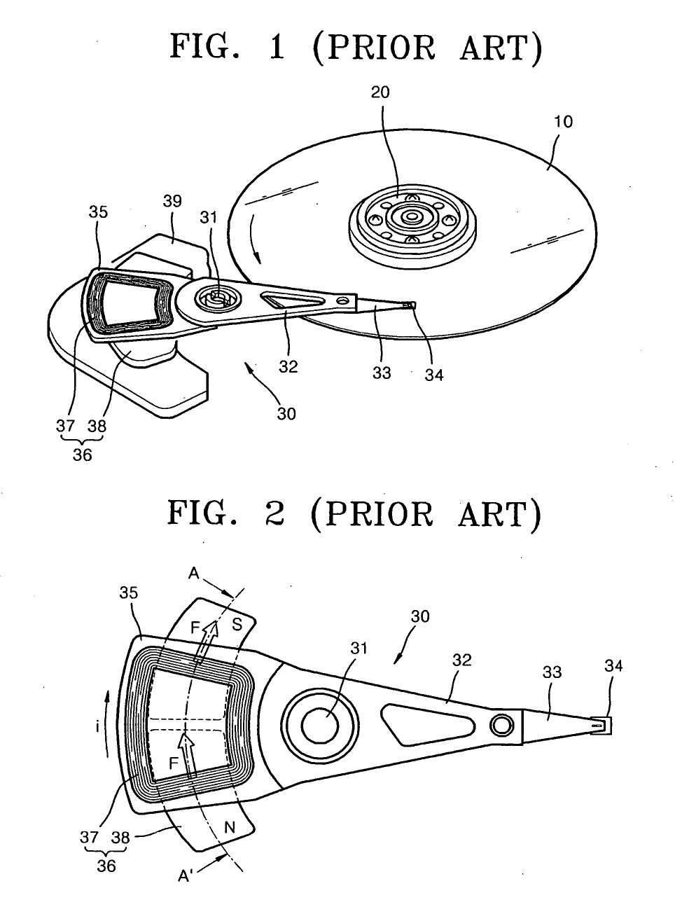

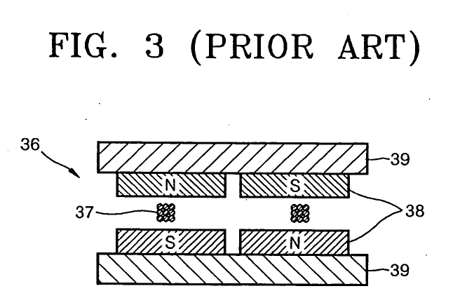

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

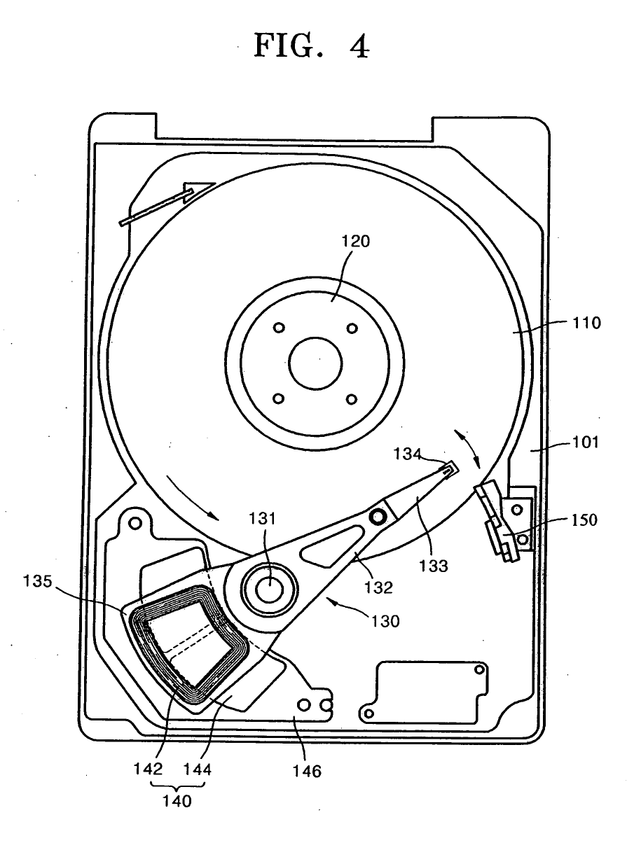

FIG. 4 is a plan view of an HDD provided with an actuator according to an embodiment of the present general inventive concept.

Referring to FIG. 4, the HDD includes a spindle motor 120 to spin a data storage disk 110 and an actuator 130 to move a read/write head to a desired position on the disk 110 to record data on the disk 110 and to reproduce data from the disk 110.

The spindle motor 120 is installed on a base member 101 of the HDD. One or more data storage disks 110 can be mounted on the spindle motor 120, and the disk(s) 110 is rotated at a constant angular speed by the spindle motor 120.

The actuator 130 includes an actuator pivot 131 installed on the base member 101, a swing arm 132, a suspension 133, a slider 134 with the read/write head, a coil support 135, and a VCM 140. The swing arm 132 is rotatably coupled to the actuator pivot 131. The suspension 133 is coupled to a leading end of the swing arm 132 elastically bias the slider 134 with the read/write head toward a surface of the disk 110. The coil support 135 is provided on a rear portion of the swing arm 132.

The VCM 140 provides a driving force to rotate the swing arm 132. The VCM 140 rotates the swing arm 132 in a specific direction according to Fleming's left-hand rule by the interaction between a current applied to a VCM coil 142 and a magnetic field formed by magnets 144. The VCM coil 142 is coupled to the coil support 135. The magnets 144 are disposed at at least one side of a top and a bottom of the VCM coil 142 to face the VCM coil 142 from the top and/or the bottom. The magnets 144 are attached to a yoke 146. The VCM coil 142 and the magnets 144 will be more fully described later.

When the HDD is powered on and the disk 110 is rotated, the VCM 140 rotates the swing arm 132 in a predetermined direction (e.g., counterclockwise) to load the slider 134 with the read/write head above a recording surface of the disk 110. The slider 134 is lifted up to a predetermined height above the surface of the disk 110 by a lift force generated by the rotation of the disk 110. In this state, the read/write head, mounted on the slider 134, records data on the recording surface of the disk 110 or reproduces data from the recording surface of the disk 110.

Meanwhile, when the HDD is turned off and the disk 110 stops rotating, the VCM 140 rotates the swing arm 132 in an opposite direction (e.g., clockwise) to move the slider 134 with the read/write head away from the recording surface of the disk 110. The slider 134, which is moved away from the recording surface of the disk 110 in this way, may be parked on a ramp 150 provided outside a circumference of the disk 110.

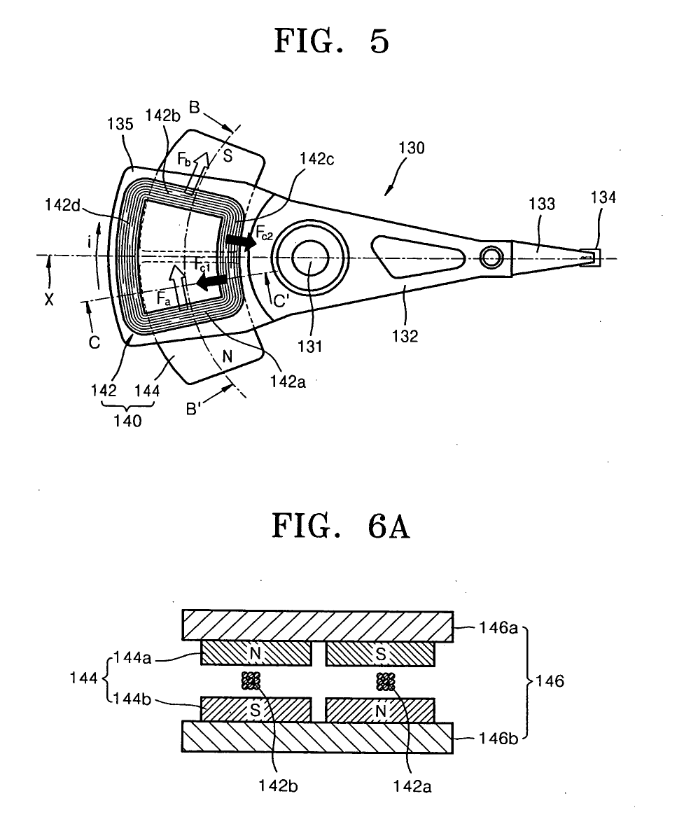

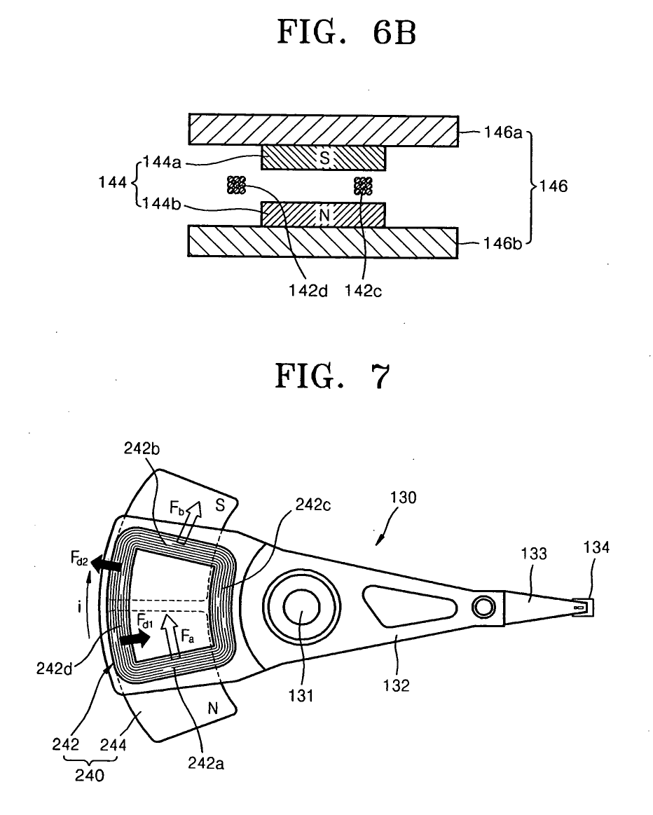

FIG. 5 is a plan view of the actuator 130 depicted in FIG. 4 according to an embodiment of the present general inventive concept, and FIGS. 6A and 6B are cross-sectional views of the VCM 140 respectively taken along line B-B′ and line C-C′ of FIG. 5 according to an embodiment of the present general inventive concept.

Referring to FIGS. 5, 6A, and 6B, in the actuator 130 of the embodiments of the present general inventive concept, the VCM coil 142 of the VCM 140 may have an approximately rectangular shape, and in this case, the VCM coil 142 includes four portions 142a, 142b, 142c, and 142d that are arranged in predetermined directions, respectively.

In detail, the VCM coil 142 includes a first portion 142a and a second portion 142b that are spaced a predetermined distance apart from each other and arranged in a direction substantially perpendicular to the rotating direction of the actuator 130. That is, the first portion 142a and the second portion 142b are respectively disposed at both sides of a longitudinal axis (X) of the actuator 130 that passes through a center of the actuator pivot 131. The VCM coil 142 includes a third portion 142c and a fourth portion 142d that connect both ends of the first portion 142a to corresponding ends of the second portion 142b to form the approximate rectangular shape. The third portion 142c and the fourth portion 142d are arranged in the rotating direction of the actuator 130. That is, the third portion 142c and the fourth portion 142d extend across the longitudinal axis (X) of the actuator 130 in a direction substantially perpendicular to the longitudinal axis (X). Further, the third portion 142c is positioned close to the actuator pivot 131, and the fourth portion 142d is positioned away from the actuator pivot 131.

The magnets 144 may include upper magnets 144a disposed above the VCM coil 142, and lower magnets 144b disposed under the VCM coil 142. It is to be noted that the terms “upper” and “lower” are used with reference to the figures as illustrated, and are not limited to specific positions. For example, if the figures were rotated by 90 degrees, the terms could be regarded as “first side magnets,” “second side magnets,” etc. The upper magnets 144a and the lower magnets 144b are supportedly attached to an upper yoke 146a and a lower yoke 146b, respectively. Meanwhile, the magnets 144 may include either or both the upper magnets 144a and/or the lower magnets 144b.

In the embodiment of FIG. 5, the upper magnets 144a and the lower magnets 144b each face the first portion 142a, the second portion 142b, and the third portion 142c, but not the fourth portion 142d. The upper magnets 144a are disposed at both sides of the longitudinal axis (X) of the actuator 130, with opposite poles facing each other. In the same manner, the lower magnets 144b are disposed at both sides of the longitudinal axis (X) of the actuator 130, with opposite poles facing each other. Here, the upper magnets 144a face the lower magnets 144b also with opposite poles facing each other.

In the actuator 130 with the above-mentioned configuration, when a current is applied to the VCM coil 142, the current through the first portion 142a, the second portion 142b, and the third portion 142c interacts with a magnetic field formed by the upper magnets 144a and the lower magnets 144b, generating forces Fa, Fb, Fc1, and Fc2 respectively acting on the first portion 142a, second portion 142b, and third portion 142c of the VCM coil 142 in specific directions according to Fleming's left-hand rule. However, since the magnetic field is not formed around the fourth portion 142d, a force does not act on the fourth portion 142d of the VCM coil 142.

In detail, the forces Fa and Fb act on the first and second portions 142a and 142b, respectively, in the same direction as the rotating direction of the actuator 130 (e.g., clockwise). The forces Fa and Fb are main forces driving the actuator 130. The forces Fc1 and Fc2 act on the third portion 142c of the VCM coil 142 in opposite directions with respect to the longitudinal axis (X) of the actuator 130. Though the directions of the forces Fc1 and Fc2 are opposed, a resultant torque is generated by the forces Fc1 and Fc2 to rotate the actuator 130 clockwise on the actuator pivot 131 since the forces Fc1 and Fc2 act in opposing directions with respect to the longitudinal axis (X) of the actuator 130. Therefore, the forces Fc1 and Fc2 acting on the third portion 142c of the VCM coil 142 can contribute to the rotation of the actuator 130 as a subsidiary driving force.

In this way, the driving force of the actuator 130 is obtained from the third portion 142c of the VCM coil 142 disposed in the rotating direction of the actuator 130 as well as from the first and second portions 142a and 142b of the VCM coil 142 disposed in a direction perpendicular to the rotating direction of the actuator 130, so that the total driving force of the actuator 130 can be increased and power efficiency can be improved.

FIG. 7 is a plan view showing an example of an actuator for comparing it with the actuator of the present general inventive concept.

A VCM 240 illustrated in FIG. 7 is configured such that magnets 244 face a first portion 242a, a second portion 242b, and a fourth portion 242d of a VCM coil 242 except a third portion 242c of the VCM coil 242. In this case, the first and second portions 242a and 242b receive forces Fa and Fb in the same direction as the rotating direction of an actuator 130 (e.g., clockwise). However, forces Fd1 and Fd2 acting on the fourth portion 242d of the VCM coil 242 generate a torque rotating the actuator 130 counterclockwise. Such a counterclockwise torque acting on the fourth portion 242d of the VCM coil 242 exerts a counteracting force against the driving force of the VCM 240. Therefore the configuration of the VCM 240 is not preferable.

As described above, according to the present general inventive concept, a driving force of an actuator can be obtained from three portions of a VCM coil, so that the driving force of the VCM can be increased and power efficiency can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An actuator to move a read/write head to a predetermined position on a disk that records data on the disk and reproduces data from the disk, the actuator comprising:
an actuator pivot;
a swing arm rotatably coupled to the actuator pivot, the swing arm having a leading end on which a suspension is mounted to support the read/write head;
a coil support provided on a rear end of the swing arm; and
a VCM (voice coil motor) including a VCM coil coupled to the coil support to provide a driving force for rotation of the actuator, and a magnet disposed at at least one of a top side and a bottom side of the VCM coil,
wherein the VCM coil includes a first portion and a second portion that are spaced apart from each other and arranged in a direction substantially perpendicular to a rotating direction of the actuator, and a third portion and a fourth portion that connect both ends of the first portion to corresponding ends of the second portion and respectively arranged in the rotating direction of the actuator, the third portion being disposed close to the actuator pivot, the fourth portion being disposed away from the actuator pivot, and
the at least one magnet faces the first portion, the second portion, and the third portion of the VCM coil.

2. The actuator of claim 1, wherein each of the first portion and the second portion of the VCM coil receives a force in the same direction as the rotating direction of the actuator, and the third portion of the VCM coil receives a torque causing the actuator to rotate on the actuator pivot in the same direction as the rotating direction of the actuator.

3. The actuator of claim 1, wherein the VCM coil has an approximately rectangular shape.

4. The actuator of claim 1, wherein the magnet is divided into parts with respect to a longitudinal axis of the actuator, the parts being respectively disposed at both sides of the longitudinal axis with opposite poles facing each other.

5. The actuator of claim 1, wherein the magnet comprises:
an upper magnet disposed above the VCM coil; and
a lower magnet disposed under the VCM coil.

6. The actuator of claim 5, wherein each of the upper magnet and the lower magnet is divided into two parts with respect to a longitudinal axis of the actuator, the two parts being respectively disposed at both sides of the longitudinal axis with opposite poles facing each other, the two parts of the upper magnet facing the two parts of the lower magnet with opposite poles facing each other.

7. A hard disk drive comprising:
a data storage disk;
a spindle motor to spin the disk; and
an actuator to move a read/write head to a predetermined position on the disk to record data on the disk and to reproduce data from the disk, the actuator including an actuator pivot, a swing arm rotatably coupled to the actuator pivot and including a leading end on which a suspension is mounted to support the read/write head, a coil support provided on a rear end of the swing arm, and a VCM including a VCM coil coupled to the coil support to provide a driving force for rotation of the actuator and a magnet disposed at at least one of a top side and a bottom side of the VCM coil,
wherein the VCM coil includes a first portion and a second portion that are spaced apart from each other and arranged in a direction substantially perpendicular to a rotating direction of the actuator, and a third portion and a fourth portion that connect both ends of the first portion to corresponding ends of the second portion and respectively arranged in the rotating direction of the actuator, the third portion being disposed close to the actuator pivot, the fourth portion being disposed away from the actuator pivot, and
the magnet faces the first portion, the second portion, and the third portion of the VCM coil.

8. The hard disk drive of claim 7, wherein each of the first portion and the second portion of the VCM coil receives a force in the same direction as the rotating direction of the actuator, and the third portion of the VCM coil receives a torque causing the actuator to rotate on the actuator pivot in the same direction as the rotating direction of the actuator.

9. The hard disk drive of claim 7, wherein the VCM coil has an approximately rectangular shape.

10. The hard disk drive of claim 7, wherein the magnet is divided into parts with respect to a longitudinal axis of the actuator, the parts being respectively disposed at both sides of the longitudinal axis with opposite poles facing each other.

11. The hard disk drive of claim 7, wherein the magnet comprises:
an upper magnet disposed above the VCM coil; and
a lower magnet disposed under the VCM coil.

12. The hard disk drive of claim 11, wherein each of the upper magnet and the lower magnet is divided into two parts with respect to a longitudinal axis of the actuator, the two parts being respectively disposed at both sides of the longitudinal axis with opposite poles facing each other, the two parts of the upper magnet facing the two parts of the lower magnet with opposite poles facing each other.

13. An actuator to move a read/write member to a predetermined position along a disk that records data on the disk and reproduces data from the disk, the actuator comprising:
an actuator pivot;
a swing arm positioned on the actuator pivot and including the read/write member connected thereto at one end and a coil support extending from the other end thereof;
a VCM coil disposed within the coil support and having four sides, a first two of the sides opposing each other and positioned substantially parallel with a rotation direction of the swing arm and a second two of the sides connecting respective ends of the first two of the sides and extending along a lengthwise axis of the swing arm, one of the second two sides being positioned close to the actuator pivot; and
at least one pair magnets, each pair of magnets being separated by the lengthwise axis of the swing arm such that one of each pair of the magnets faces one of the first two sides of the VCM coil and the one of the second two sides of the VCM coil being positioned close to the actuator pivot and the other of each pair of the magnets faces the other of the first two sides of the VCM coil and the one of the second two sides of the VCM coil being positioned close to the actuator pivot.

14. The actuator of claim 13, wherein the at least one pair of magnets includes a pair of magnets positioned along a plane at one side of the VCM coil and a pair of magnets positioned along a plane at another side of the VCM coil.

15. The actuator of claim 13, wherein each pair of magnets being separated by the lengthwise axis of the swing arm have opposite poles facing each other such that when a current is sent through the VCM coil, a first force is applied to the one of the first two sides of the VCM coil, a second force is applied to the second of the first two sides of the VCM coil, a third force is applied to one side of the one of the second two sides of the VCM coil being positioned close to the actuator pivot and a fourth force is applied to another side of the one of the second two sides of the VCM coil being positioned close to the actuator pivot.

16. The actuator of claim 14, wherein each pair of magnets being separated by the lengthwise axis of the swing arm have opposite poles facing each other such that when a current is sent through the VCM coil, a first force is applied to the one of the first two sides of the VCM coil, a second force is applied to the second of the first two sides of the VCM coil, a third force is applied to one side of the one of the second two sides of the VCM coil being positioned close to the actuator pivot and a fourth force acting in an opposite direction from the third force is applied to another side of the one of the second two sides of the VCM coil being positioned close to the actuator pivot.

17. A method of controlling a VCM driven actuator used to read and write from and to a disk of a hard disk drive, the method comprising:
applying a force to each of three sides of a four sided VCM coil provided on the actuator to rotate the actuator via a combination of the three forces.

18. The method of claim 17, wherein the applying of a force to each of the three forces comprises:
positioning at least one first magnet to face one of the three sides of the VCM coil and a first portion of a second side of the VCM coil;
positioning at least one second magnet to face a third one of the three sides of the VCM coil and a second portion of the second side of the VCM coil, the first and third sides of the VCM coil being positioned parallel with the length of the actuator, and the second side of the VCM coil being parallel with a rotation direction of the actuator and substantially perpendicular with the first and third sides of the VCM coil; and
providing a current through the VCM coil to interact with the magnets to generate the forces applied to the three sides of the VCM coil.

19. The method of claim 18, wherein the positioning of the at least one first magnet and the at least one second magnet comprises positioning a first magnet at each side of the VCM coil and positioning a second magnet at each side of the VCM coil such that the magnets have opposite poles facing each other.

20. A method of controlling a VCM driven actuator used to read and write from and to a disk of a hard disk drive, the method comprising:
applying opposing forces to one side of a four sided VCM coil provided on a rear portion of the actuator to create an overall torque to rotate the actuator, the one side of the VCM coil being positioned in parallel with a rotation direction of the actuator.

21. The method of claim 20, wherein the applying opposing forces comprises:
positioning a first magnet to face a first portion of the one side of the VCM coil and positioning a second magnet to face a second portion of the one side of the VCM coil; and
passing a current through the VCM coil to generate a first force that is applied to the first portion of the one side of the VCM coil and to generate a second force that is applied to the second portion of the one side of the VCM coil such that the first and second forces create the overall torque.
